(19) United States
(12) Patent Application Publication
(10) Pub. No.: US 2021/0170705 A1
(43) Pub. Date: Jun. 10, 2021

(54) RETREADING METHOD FOR A TIRE COMPRISING AN ELECTRONIC ASSEMBLY

(71) Applicant: COMPAGNIE GENERALE DES ETABLISSEMENTS MICHELIN, Clermont-Ferrand (FR)

(72) Inventors: THOMAS MOSNIER, Clermont-Ferrand (FR); LIONEL FAGOT-REVURAT, Clermont-Ferrand (FR)

(21) Appl. No.: 16/762,679

(22) PCT Filed: Nov. 5, 2018
(86) PCT No.: PCT/IB2018/058652

§ 371 Date: May 8, 2020

(30) Foreign Application Priority Data
Nov. 8, 2017 (FR) 17/71177

(51) Int. Cl. B29D 30/54

(52) U.S. Cl. CPC B29D 30/54

(57) ABSTRACT

A retreading method for a tire comprising an electronic assembly (1) provided with an electronic module, a rubber patch fastened to an inner wall of the tyre, said patch including a seat designed to house an active portion of the electronic module, comprises the following steps: removing the electronic module from the patch used for fastening, placing a protective cover (40) that is resistant to vulcanization on the patch so as to cover the patch, placing a new tread on the tire, vulcanizing the tyre with the new tread, removing the protective cover (40) from the patch, and re-inserting the electronic module into the rubber patch.

### TECHNICAL FIELD OF THE INVENTION

The present invention relates to a method and a system for retreading a tyre comprising an electronic assembly including a patch provided with a seat designed to house an electronic module.

### PRIOR ART

In general, two solutions for fastening electronic tyre modules are known.

The first solution involves incorporating an electronic module into the tyre by fastening said electronic module permanently. To do so, the electronic module is mechanically and irreversibly fastened rigidly to the tyre. Such an arrangement provides a reliable fastening of the module, obviating all risk of the module becoming detached from the tyre. However, this solution prevents the electronic module from being replaced or modified. As a result, this solution is not compatible with electronic systems that are designed to be removable.

For example, document FR2870031 describes a tyre monitoring method fitted to a land vehicle. This method is implemented using a central control unit and electronic chips embedded in the sides of the tyre. The chips of a given tyre contain identical identification codes and respective codes representing their installation on said tyre.

The second solution involves incorporating an electronic module using a patch, often made of rubber, in which the module is seated removably.

For example, document FR3028451 describes a device for fastening, to the inner wall of a tyre, an electronic unit for measuring parameters inside the tyre, the device associating said unit with a flexible receptacle that is fastened to said inner wall using adhesion means and is preformed to receive and retain said unit, characterized in that said flexible receptacle forms a compartment with an opening through which said unit is inserted, said opening having an outwardly extending rim providing a contact surface for the adhesion means so that, once the receptacle has been fastened, said opening is closed by the inner wall to which the receptacle is fastened. Consequently, once the receptacle has been fastened to the wall of the tyre, the electronic module can only be removed if the receptacle is removed. The receptacle therefore has to be changed each time the electronic module is removed.

Document EP2777958 describes an elastomeric encasement comprising a rubber part containing a cavity to releasably hold a module for use in assisting operation of a tyre. The cavity is designed with an opening to facilitate inserting the module into and removing the module from the cavity. The elastomeric encasement comprises an uncured or partially cured rubber composition. In most of the embodiments presented, the slot enabling insertion of the electronic module is positioned on the top of the rubber part. In such arrangements, the cavity is not sealed. The arrangement of the slot entails a risk of the module being ejected. An arrangement with a lateral opening is presented. However, this opening cannot be re-closed and the module remains exposed to potential contaminants, fluids and dust liable to be found in the cavity of the tyre.

The solutions disclosed in the prior art have certain imperfections in all of the arrangements thereof. There is therefore a need for an effective solution for removably fastening an electronic module to an inner wall of a tyre, while minimizing the risk of damage being caused to the tyre if a module becomes detached from the fastening point thereof.

Moreover, the fastening patches are often mounted on tyres liable to undergo retreading. It is therefore essential to provide means to carry out retreading despite the presence of fragile elements.

The invention provides various technical means for overcoming these drawbacks.

### DESCRIPTION OF THE INVENTION

A first objective of the invention involves providing means for effectively protecting a patch during the retreading process of a tyre to which a patch is fastened.

Another objective of the invention is to provide means for protecting the patch that are simple to make and easy to apply and remove.

To do so, the invention provides a retreading method for a tyre comprising an electronic assembly provided with an electronic module, a rubber patch fastened to an inner wall of the tyre, said patch including a seat designed to house an active portion of the electronic module, said method comprising the following steps:

removing the electronic module from the patch used for fastening,

placing a protective cover that is resistant to vulcanization on the patch so as to cover the patch,

placing a new tread on the tyres,

vulcanizing the tyre with the new tread,

removing the protective cover from the patch,

re-inserting the electronic module into the rubber patch.

The cover protects the patch during the vulcanization step. Furthermore, the cover provides good thermal insulation.

Advantageously, the protective element is placed on the patch by clipping said protective element onto the patch to be covered.

This fastening method is practical and provides an effective hold without any risk of accidental detachment.

The invention also provides a retreading system for a tyre comprising an electronic assembly provided with an electronic module, a rubber patch fastened to an inner wall of the tyre, said patch including a seat designed to house an active portion of the electronic module, said patch having outer side walls that are inclined to form an external dovetail profile, said system also having a protective cover for the patch that is designed to cover said patch, said cover having inner side walls that are inclined to form an internal dovetail profile that is designed to hold the cover on the patch.

This system is relatively inexpensive and enables the tyre to be reused several times without damaging the patch.

Advantageously, the protective cover is thermally insulating.

This feature prevents premature ageing or damage of the patch.

Also advantageously, the protective cover is made of silastene.

According to an advantageous embodiment, the protective cover can be clipped onto the patch.

### DESCRIPTION OF THE FIGURES

Full implementation details are provided in the description given below, which is complemented by FIGS. 1a to 5, which are provided purely as non-limiting examples, in which:

FIG. 1a is a perspective view of an example electronic assembly,

FIG. 1b is a top view of the electronic assembly in FIG. 1a,

FIG. 2 is a perspective view of an example electronic module,

FIG. 3a is a perspective view of the electronic module in FIG. 2 with a protective envelope,

FIG. 3b is a top view of the electronic module in FIG. 3a with the protective envelope,

FIG. 4a is a perspective view of an example patch,

FIG. 4b is a bottom view of the patch in FIG. 4a,

FIG. 4c is a longitudinal cross section of the patch in FIG. 4a showing the internal seat,

FIG. 4d is a sectional elevation of the patch in FIG. 4a,

FIG. 5 is an elevation of the rear of an example patch on which a protective cover has been placed.

### DETAILED DESCRIPTION OF THE INVENTION

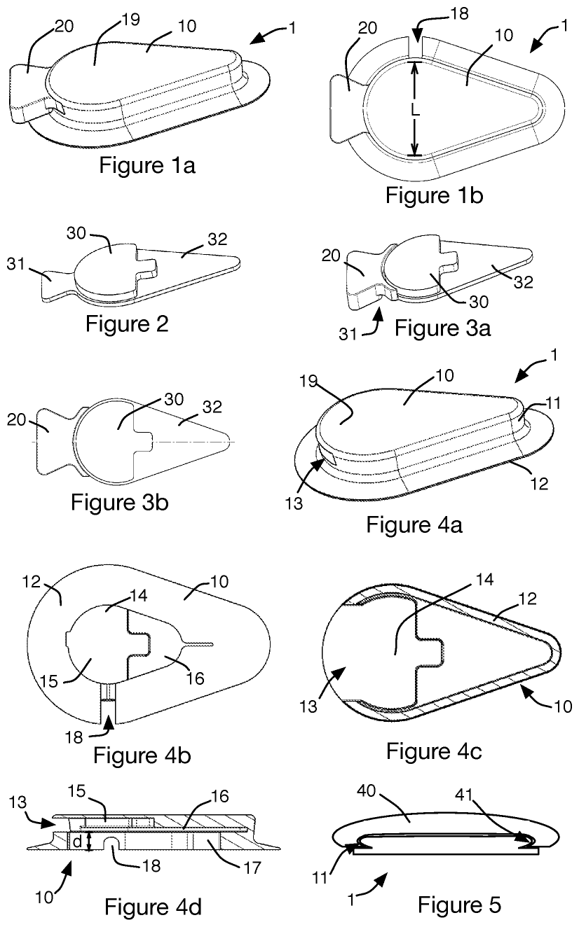

As illustrated in FIGS. 1a, 1b, 2, 3a and 3b, the electronic tyre assembly 1 comprises an electronic tyre module 30 including a gripping head 31, a rubber patch 10 provided with a seat 14 for insertion of the electronic module 30, and a rubber protective envelope 20 specifically designed to cover the gripping head 31 of the electronic module 30.

The electronic module 30 is designed to provide identification data on the tyre and data relating to the physical operating parameters of the tyre to which the assembly (1) is fastened.

As shown in FIGS. 2, 3a and 3b, the electronic module 30 is substantially elongate, along an axial profile oriented along the axis A-A. The electronic module also includes a gripping head 31 that is also oriented along the axis A-A and that is designed to extend beyond the patch 10 when the active portion of the electronic module 30 is positioned in the seat 14 of the patch. The gripping head enables a user to handle the electronic module to insert and/or remove the electronic module from the patch. In the examples shown, for example in FIGS. 4b and 4d, the electronic module is provided with an antenna zone 16 and a zone for electronic components (other than the antenna). As shown, the electronic component zone 15 is thicker than the antenna zone 16, which is easy to form with using a minimal thickness.

In the examples shown, the thin antenna zone preferably has a substantially conical axial profile. The component zone 15 has a substantially circumferential axial profile.

The patch is shown in FIGS. 1a and 1b. The patch has a seat 14 that is designed to house the active portion of the electronic module 30.

Like the electronic module that the patch houses and protects, the patch 10 has a substantially elongate axial profile with a base 12 and a top 19 that are separated by a side wall 11.

As shown in particular in FIGS. 4a and 4c, the patch 10 has a side opening 13 that communicates with the seat 14. This side opening 13 enables insertion and/or removal of the active portion of the electronic module 30 in the seat 14. This opening 13 is arranged on the side wall 11, on the side of the circumferential profile. The surface of the opening 13 is substantially smaller than the maximum transverse surface of the electronic module 30 in order to provide a somewhat tight closure that is enough for positioning and sealing. The surface difference is advantageously in the order of 10%.

The side orifice 18, which is shown in FIGS. 4b and 4d, enables fluid communication with the cavity of the tyre when the patch 10 is positioned against the inner wall of the tyre.

Like the electronic module 30, the patch 10 and the electronic module seat 14 have a substantially conical axial profile on the side opposite the side opening 13. Furthermore, the patch has a substantially circumferential axial profile on the side of said side opening 13.

Moreover, in order to match the architecture of the electronic module 30, the electronic module seat 14 has two zones: an antenna zone 16 on the side of the substantially conical axial profile, and an electronic component zone 15 on the side of the substantially circumferential axial profile.

The electronic component zone 15 is thicker than the antenna zone 16.

As shown in FIG. 4d, the seat 14 is positioned at a distance “d” from the base 12. An air chamber 17 is formed beneath the seat 14. This chamber is for example used to house a porous foam insert designed to protect the electronic components.

To make the electronic assembly uniform and to protect the electronic module, the gripping head 31 of the electronic module 30 is covered by a rubber protective envelope 20, as shown for example in FIGS. 3a and 3b. This envelope is provided to substantially seal the patch 10 when the active portion of the electronic module 30 is housed in the seat 14 thereof.

### Retreading Method and System

FIG. 5 shows another aspect of the invention relating to a system and method for retreading tyres including an electronic assembly, as described above, fastened to an inner wall of a tyre.

In the system provided and as shown in FIG. 5, the patch has outer side walls 11 that are inclined to form an external dovetail profile. The system also has a protective cover 40 for the rubber patch 10 that is designed to cover said patch. Like the outer walls of the patch 10, the protective cover 40 has inner side walls 41 that are inclined to form an internal dovetail profile that is designed to hold the cover 40 on the patch 10. The cover is easy to position, for example by clipping the cover onto the patch. To facilitate removal thereof, the cover 40 can be deformed elastically to unclip the cover from the patch. The cover placed against the patch protects the patch during the vulcanization operation performed at the end of a tyre retreading method cycle. The vulcanization of the new tread is thus carried out without risking damaging the patch, which could otherwise crack or form breakage start zones without such protection. For this purpose, the cover 40 is advantageously made of silastene.

An advantageous retreading method can be implemented using the retreading system described above, and more specifically the cover 40. This implementation also involves removing the electronic module 30 from the patch 10 used for fastening in order to prevent this element, which is particularly fragile and sensitive to heat and pressure, from being damaged by the extreme conditions occurring during the vulcanization phase. A new tread is applied to the tyre. A preparation step is advantageously applied to the receiving surface of the tread in order to optimize application and encourage a lasting hold of the new tread. A protective cover 40 that is resistant to vulcanization is placed on the patch so as to cover the patch. This step is performed before vulcanization and, where applicable, before the new tread is applied. The vulcanization step of the tyre with the new tread is then performed, with the cover 40 protecting the patch. After removal from the mould, the protective cover 40 of the patch can be removed and the electronic module 30 reinserted into the rubber patch 10.

This retreading method enables a new tread to be positioned and vulcanized on a tyre carcass with an electronic assembly as described above.

### REFERENCE NUMBERS USED IN THE FIGURES

1 Electronic assembly
10 Rubber patch
11 Outer side wall of the patch (inclined)
12 Base
13 Opening
14 Seat
15 Component zone
16 Antenna zone
17 Air chamber
18 Communicating orifice
19 Top of the patch
20 Rubber protective envelope
30 Electronic module
31 Gripping head
32 Antenna
40 Protective cover
41 Inner side wall (inclined and substantially matching the outer wall of the patch)

1.-6. (canceled)

7. A retreading method for a tire comprising an electronic assembly provided with an electronic module, a rubber patch fastened to an inner wall of the tire, the patch including a seat configured to house an active portion of the electronic module, the method comprising:
removing the electronic module from the patch used for fastening;
placing a protective cover that is resistant to vulcanization on the patch so as to cover the patch;
placing a new tread on the tire;
vulcanizing the tire with the new tread;
removing the protective cover from the patch; and
re-inserting the electronic module into the rubber patch.

8. The retreading method according to claim 7, wherein the protective cover is placed on the patch by clipping the protective cover onto the patch to be covered.

9. A retreading system for a tire comprising an electronic assembly provided with an electronic module, a rubber patch fastened to an inner wall of the tire, the patch having a seat configured to house an active portion of the electronic module, the patch having outer side walls that are inclined to form an external dovetail profile, the system also including a protective cover for the patch that is configured to cover the patch, the protective cover having inner side walls that are inclined to form an internal dovetail profile that is designed to hold the cover on the patch.

10. The retreading system according to claim 9, wherein the protective cover is thermally insulating.

11. The retreading system according to claim 9, wherein the protective cover is made of silastene.

12. The retreading system according to claim 9, wherein the protective cover can be clipped to the patch.
